(19) United States
(12) Patent Application Publication
(10) Pub. No.: US 2005/0175027 A1
(43) Pub. Date: Aug. 11, 2005

(54) System and method for requesting and granting access to a network channel

(75) Inventors: Michael J. Miller, Pleasant Grove, UT (US); Lyman D. Horne, Salt Lake City, UT (US); W. Paul Willes, Alpine, UT (US); Douglas M. Grover, Elk Ridge, UT (US)

Correspondence Address: Lloyd W. Sadler;Parsons Behle & Latimer, Suite 1800, 201 South Main Street, Salt Lake City, UT, 84111, US

(73) Assignee: Phonex Broadband Corporation, Midvale, UT (US)

(21) Appl. No.: 10/775,359

(22) Filed: Feb. 9, 2004

(51) Int. Cl. H04L 12/43

(52) U.S. Cl. 370/458

(57) ABSTRACT

A network access system designed to provide efficient access to nodes using a communication channel based on the needs of the system. This invention provides a specific design for token based access scheme which allows access based on priority, time, and data requirements. Also included is a unique collision detection and token granting mechanism. These designs provide for nodes to efficiently request and gain access to network bandwidth and are adaptive to allow for different data types such as voice, video, control, and data over networks such as power line or wireless.

### BACKGROUND OF INVENTION

1. Field of the Invention

This invention relates to electronic communication systems. More specifically, this invention relates to granting and prioritizing network access within a communication system.

2. Description of Related Art

A variety of token passing schemes have been used for access to a network. For example token ring (IEEE 802.5) and token bus (IEEE 802.4) are used as general token passing mechanisms. These methods typically use a logical ring for token passing and are typically used on non Time Division Multiplexed networks and are not adaptive for networks such as wireless and power line systems. Although these references may not constitute prior art, for a general background material, the reader is directed to the following United States patents, each of which is hereby incorporated by reference in its entirety for the material contained therein: U.S. Patent and Patent Application Nos. 2002/0178250, 2002/0013805, 2002/0048368, U.S. Pat. No. 5,948,089, 5,878,273, 5,828,907, 5,812,547, 5,784,648, 5,689,644, 5,630,173, 5,422,885, 5,253,252, 5,140,586, 4,886,706.

### SUMMARY OF INVENTION

It is desirable to provide a system for requesting and granting access to nodes on a network in an efficient manner while providing redundancy and fault tolerance. Therefore it is a general object of an embodiment of this invention to provide a system for requesting and granting access to Time Division Multiplexed (TDM) network channels.

It is a further object of an embodiment of this invention to provide a system for requesting and granting access on a wireless network, a light frequency network, a power line network, and a wired network.

It is a further object of an embodiment of this invention to provide a system for requesting and granting access on a network based on queue identifier value, a queue priority value, a time to live value, and an access duration value.

It is a further object of an embodiment of this invention to provide a system for requesting and granting access on a network based on a contention resolution algorithm.

It is a further object of an embodiment of this invention to provide a system for requesting and granting access on a network based on a packet or packets.

It is a further object of an embodiment of this invention to provide a system for requesting and granting access on a network based on a logical ring contention resolution algorithm.

It is a further object of an embodiment of this invention to provide a system for requesting and granting access on a network wherein access is re-granted based on packet reassembly.

It is a further object of an embodiment of this invention to provide a system for relinquishing access to a network based on lack of access requests.

It is a further object of an embodiment of this invention to provide a system relinquishing access to a network on sending out a packet.

It is a further object of an embodiment of this invention to provide a system for assuming access mastership based on no response to access requests.

These and other objects of this invention will be readily apparent to those of ordinary skill in the art upon review of the following drawings, detailed description, and claims. In the preferred embodiment of this invention, the invention makes use of a novel network access mechanism that allows nodes to request and gain access to network channels in an efficient and fault tolerant manner. In addition there is a novel process for determining which nodes are responsible for providing network access on the network channel.

### BRIEF DESCRIPTION OF DRAWINGS

In order to show the manner that the above recited and other advantages and objects of the invention are obtained, a more particular description of the preferred embodiments of this invention, which are illustrated in the appended drawings, is described as follows. The reader should understand that the drawings depict only present preferred and best mode embodiments of the invention, and are not to be considered as limiting in scope. A brief description of the drawings is as follows:

FIG. 1a is a diagram of the present preferred network for sending packets between network nodes.

FIG. 1b is a diagram of the Time Division Multiplexed structure of the present preferred embodiment of this invention used to transfer data.

FIG. 1c is a packet diagram of the present preferred access request and granting process on a network channel.

FIG. 1d is a flow diagram of the present preferred method for requesting access from a network node.

FIG. 1e is a flow diagram of the present preferred method for granting access from an access server.

FIG. 1f is a flow diagram of the present preferred method of adding requests to the request queues.

FIG. 2a is a flow diagram of the present preferred method of a node being granted access and sending data.

FIG. 2b is a packet diagram of the present preferred access request and granting process when an upper layer packet is not sent completely during an access period.

FIG. 3 is a packet diagram of the present preferred process for an access server going inactive and active based on access requests.

FIG. 4a is a diagram of the present preferred request queue prioritization method used for granting access to the channel.

FIG. 4b is a flow diagram of the present preferred method for determining which request will be serviced.

FIG. 5 is a diagram of the present preferred relationship between packets received by the access server and a nodes time to live value.

FIG. 6 is a flow diagram of the present preferred time to live algorithm.

FIG. 7 is a flow diagram of the present preferred method for a node becoming an access server.

FIG. 8 is a diagram of the present preferred network for sending data segments between network nodes.

FIG. 9 is a diagram of the Time Division Multiplexed structure of the present preferred embodiment of this invention used to transfer data on a network.

FIG. 10 is a flow diagram of the present preferred virtual channel creation process from the node which is requesting to create a virtual channel.

FIG. 11 is a flow diagram of the present preferred virtual channel creation process from the node which is being requested to be apart of the virtual channel.

FIG. 12 is a flow diagram of the present preferred virtual channel removal process once a virtual channel is created.

FIG. 13 is a flow diagram of the present preferred control node active channel creation process.

FIG. 14 is a flow diagram of the present preferred channel creation process for a peer active channel.

FIG. 15 is a diagram of the present preferred dynamic active channel resizing.

FIG. 16 is a flow diagram of the present preferred process for bandwidth allocation using channel priorities.

FIG. 17 is a flow diagram of the present preferred process for bandwidth reclamation in a control node active channel.

FIG. 18 is a flow diagram of the present preferred process for notifying network nodes that the network node is no longer part of an active channel.

FIG. 19 is a diagram of the present preferred process for bandwidth reclamation in a peer active channel.

Reference will now be made in detail to the present preferred embodiment of the invention, examples of which are illustrated in the accompanying drawings.

### DETAILED DESCRIPTION

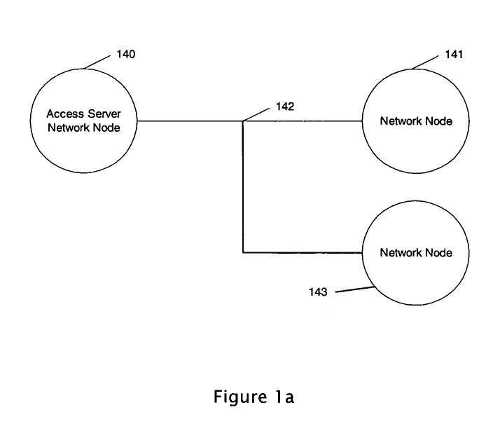

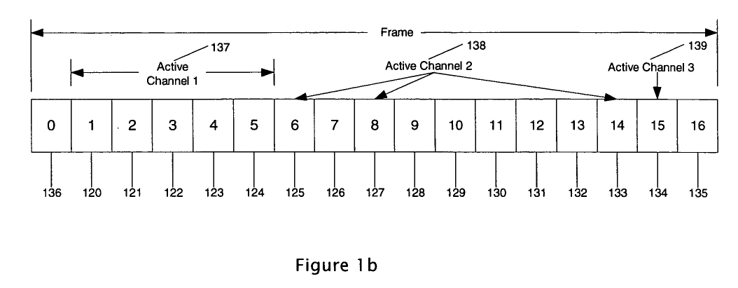

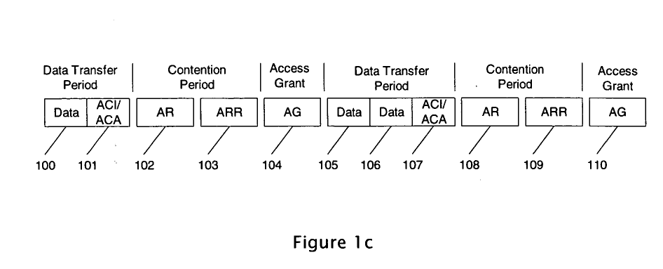

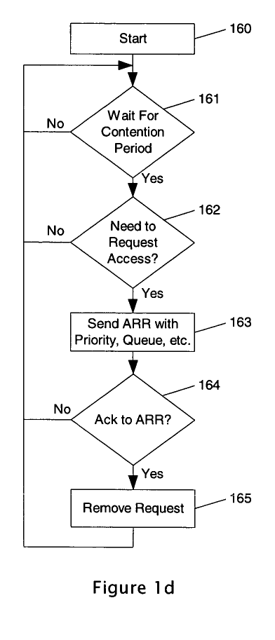

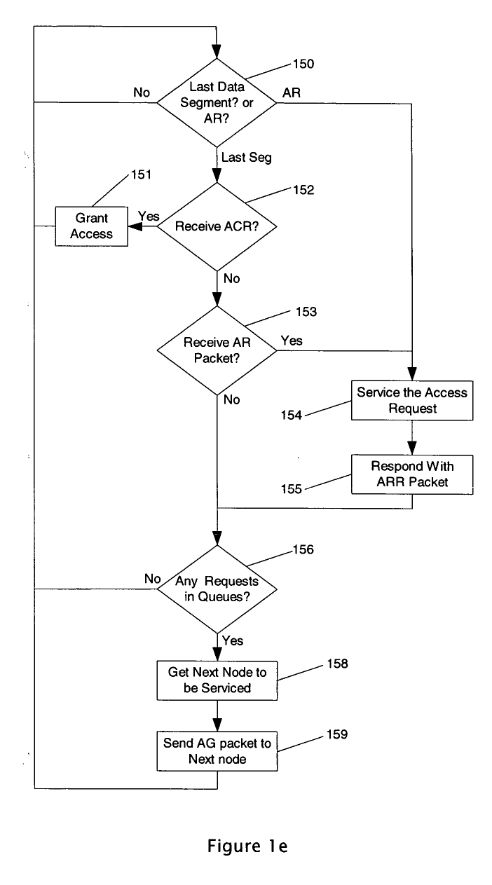

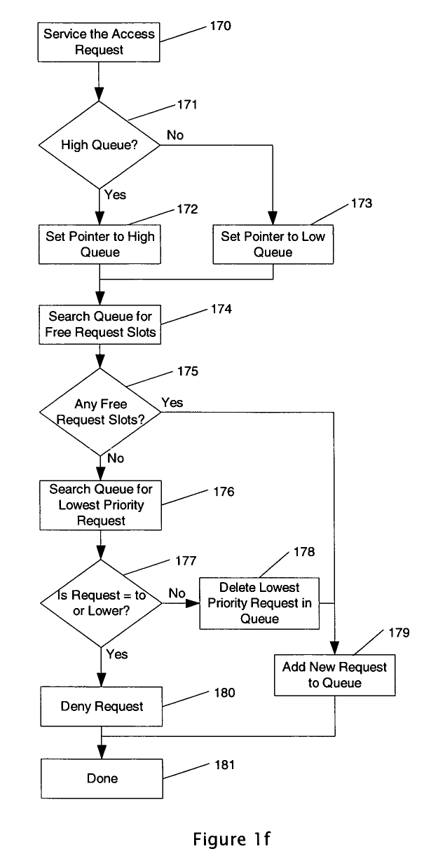

FIG. 1a is a diagram of the present preferred network for sending packets between network nodes. In this document when referring to a network node in the singular, while referencing the single node with multiple nodes indicates that all referenced nodes can perform the same function as the single network node. A network 142 is formed by plurality network nodes 140, 141 and 143. One of the network nodes 140 is also an access server which grants access to network nodes 140, 141, 143. Any node 140, 141, 143 can assume the role of access server if necessary. These packets are sent across a time division network which comprises time slots 120-136.

FIG. 1b is a diagram of the Time Division Multiplexed structure of the present preferred embodiment of this invention used to transfer data. Transfer of data across a network 142 occurs in two forms: packet and non-packet. Examples of data include but are not limited to voice, audio, control, video, and computer information. A frame represents the bandwidth of the network 142 over time and consists of a plurality of time slots 120-136. Time slots 120-136 in the present preferred embodiment are equal size pieces of Time Division Multiplexed (TDM) bandwidth which is used to transfer data over the AC power line. Each time slot is 10 bits wide. The actual data sent is 32 bits with 22 bits used for forward error correction which results in 10 bits for each time slot. Time slot 136 is used for frame synchronization across the network 142 and time slots 120-135 are used for data transfer. Data is sent using active channels, which are pieces of network 142 bandwidth. An active channel is a variable or fixed size pipe made up of a single time slot or a plurality of time slots used to form a packet or non-packet pipe. For example, an active channel 137 can comprise but is not limited to a group of contiguous slots 120-124. On the other hand, an active channel 138 can consist of noncontiguous slots 126, 128, 133. In addition, an active channel can comprise a single time slot 139 or any number of time slots up to the maximum number of time slots in the frame.

To resolve the access method of how devices send packets within an active channel 137-139, the media access layer provides an access server 140 responsible for granting access for sending packets within active channels 137-139 on a network 142. An active channel 137-139 is a single time division multiplexed slot or group of slots in which network nodes 140, 141, 143 transfer data. For each active channel 137-139 there is a network node 140, which is designated as an access server 140 that is responsible for granting access to each network node 140, 141, 143 in the channel 137-139. There are two types of active channels 137-139 that are used on the network 142: 1) A control node channel, and 2) A peer channel. A control node channel is an active channel where there is a dedicated node responsible for setting up an active channel and granting access (access server 140) to that channel. A peer channel is a channel where any node within the active channel can create the active channel and also assume the role of access server 140. Thus, there is an access server 140 for each active channel 137-139. A single network node 140 can be an access server for multiple channels 137-139 or there can be multiple access servers on different network nodes providing access on different active channels 137-139. There are nine types of packets associated with requesting and granting of access to the network 142: 1. Access Request (AR) A request by a network node 141 to gain access to an active channel 137-139.

2. Quiet Access Request (QAR) When a network node 141 first comes up or needs to send data and cannot detect an access server 140 on an active channel, the network node 141 will send this packet which will activate the access server 140. If there is no response, the network node 141 may become the access server 141.

3. Access Request Response (ARR) The response from the access server 140 to an AR packet.

4. Access Grant (AG) The passing of the token from the access server 140 to a network node 141, which allows the network node 141 to send data.

5. Access Grant Final (AGF) The passing of the grant from the access server 140 to a network node 141, which allows the network node 141 to send data. The network node 141 is removed from the access server's 140 queue 416, 417 and must do an AR to send again.

6. Access Continue Request (ACR) The response from a network node 141 when the network node 141 has sent its data in the access period, but the network node 141 still has some segments to complete the upper layer packet.

7. Access Complete Active (ACA) The response from a network node 141 when the network node 141 has completed its data transfer cycle, but still has more data to send.

8. Access Complete Inactive (ACI) The response from a network node 141 when the network node 141 was granted access but has no data to send.

9. Access Server Inactive (ASI) When the access server 140 has not seen any traffic for a long period of time. The access server 140 will stop sending contention period packets.

Devices on an active channel 137-139 detect where a new packet begins by detecting a known preamble and checking the packet length and Cyclic Redundancy Check (CRC) at the end of the packet. If the CRC is valid, the network node 141 knows where the next packet will begin. If a preamble is detected in the next frame, a network 141 node has started to send. This begins a new access (token) period. FIG. 1c is a packet diagram of the present preferred access request and granting process on a network channel. There are three main phases that are used by a network node 141 in order to get access and send data. First, is the contention period. Typically, after a network node 141 has sent its last data segment 100, the network node 141 either sends an Access Complete Active 101 or an Access Complete Inactive 101. The Access Complete Active or Access Complete Inactive indicates the beginning of a new contention period. The contention period is where network nodes 141 send out Access Requests 102 in order to get access in the send queues 416 or 417 for sending data. This request includes: 1) Which queue 416, 417 (high or low), 2) Queue priority (determines who stays in the queue), 3) Time to Live (How long before the request is removed from the queue), and 4) Data Transfer Period (How much data can be sent during a token period). The access server 140 acknowledges the Access Request with an Access Request Response 103 by either adding the request to the requested queue 416, 417 for service or negatively acknowledging 103 the request because of higher priority requests in the queues 416, 417. If a network node 141 requests the high queue 416 and is negatively acknowledged, the network node 141 can re-request access to the lower queue 417 if necessary during a later contention period. If two nodes collide during the access contention period, they start a random back-off period that causes them to request access in a future contention period. This random back mechanism can be replaced with some other contention resolution algorithm such as a logical ring, and the like. If there is no collision, the access server 140 will respond with and Access Request Response packet 103. At this point, the access server 140 starts the access grant period and determines which network node 141, 143 will get access based on the access granting algorithm (described later) and grants access to a network node 141 by sending an Access Grant 104 packet. The network node 141, which was granted access, enters the data transfer period and sends data packets 105-106 based on the network node's 141 Access Duration value. The network node 141 will send either an Access Complete Active 107 or an Access Complete Inactive 107 packet that signifies the end of data transfer and the beginning of a new contention period. The process repeats with a new Access Request packet 108 and a corresponding Access Request Response 109 packet. The access server 140 sends the Access Grant packet 110 to start the data transfer period.

FIG. 1d is a flow diagram of the present preferred method for requesting access from a network node 140, 141, 143. The process begins 160 when a network node 141 checks 161 for the start of a contention period. If the start of a contention period is not detected, the process waits 161 until a contention period starts. Once the contention period starts, the process checks 162 to see if the network node 141 needs access to an active channel 137-139. If not, the process waits for the next contention period 161. Otherwise, the process sends 163 an ARR packet with the queue priority, which queue, access duration, and the time to live values set. If the network node 141 receives 164 an access request response from the access server 140, the network node 141 removes the request because the access server 140 has added the request to the requested queue 416 or 417. Otherwise, the process waits 161 for a new contention period so the request can be tried again.

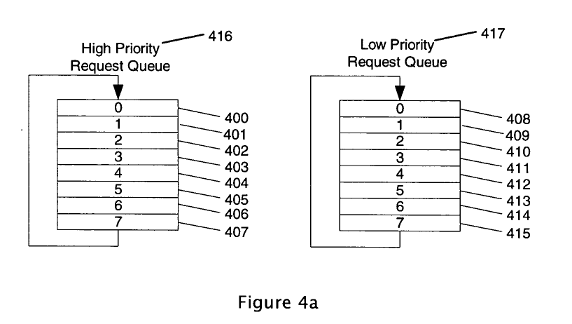

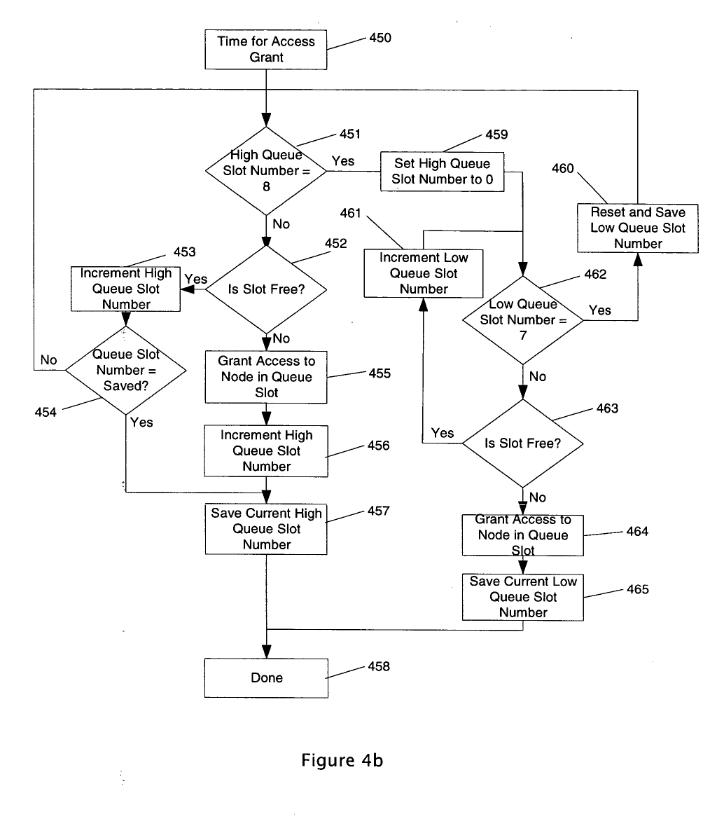

FIG. 1e is a flow diagram of the present preferred method for granting access from an access server 140. The process begins 150 on the access server 140. If in test 150, the last data segment from a network node 140, 141, 143 has not been sent, the process waits until the last segment is seen 150. If an AR packet is seen when no data transfer has occurred, the process flows to step 154. Once the last data segment was seen, the process checks 152 to see if an ACR was sent. If so, the process grants access 151 to the network node 141 that sent data last. This is because the network node 141 has not sent all of an upper layer packet. The process waits 150 for the last data segment again. Otherwise, if in test 152 an ACR was not received, the process checks 153 to see if an AR packet was received. If so, the process services 154 the access request and responds 155 with an ARR packet. The response packet 155 may be a positive or negative response. Step 154 is defined in further detail in FIG. 1f. The process flows to test 156. If test 153 is no, the process also flows to test 156. Test 156 checks to see there are any requests still in the queues 416, 417. Test 156 is further defined in FIG. 4b. If there are no requests in the queues 416, 417, there is no need to grant access so the process waits 150 for the last data segment. Otherwise, the process gets 158 the next network node 140, 141 or 143 that needs servicing and grants access 159 to the network node 140, 141 or 143.

FIG. 1f is a flow diagram of the present preferred method of adding requests to the request queues 416, 417. FIG. 1f is a detailed flow diagram of steps 154. The process begins with the servicing 170 of a received access request. The process checks 171 to see if the request is for the high queue 416 or the low queue 417. If the request is for the high queue 416 a pointer is set 172 to point to the high queue 416. Otherwise, the pointer is set to point to the low queue 173. The process checks 175 the queue 416 or 417 for any free slots. If there is a free slot, the request is added 179 to the queue 416 or 417 and the process completes 181. Otherwise, if the queue 416 or 417 is full of requests, a search 176 is performed to get the lowest priority request in the queue 416 or 417. Test 177 checks to see if the lowest priority request currently in the queue 416 or 417 is lower than the current request. If the current request is the lowest or equal to the lowest request in the queue 416 or 417, the request is denied 180 and the process completes 181. Otherwise, if the request is higher than the lowest request in the queue 416 or 417, the lowest request in the queue is deleted 178 and the new request is added 179 to the queue 416 or 417 and the process completes 181.

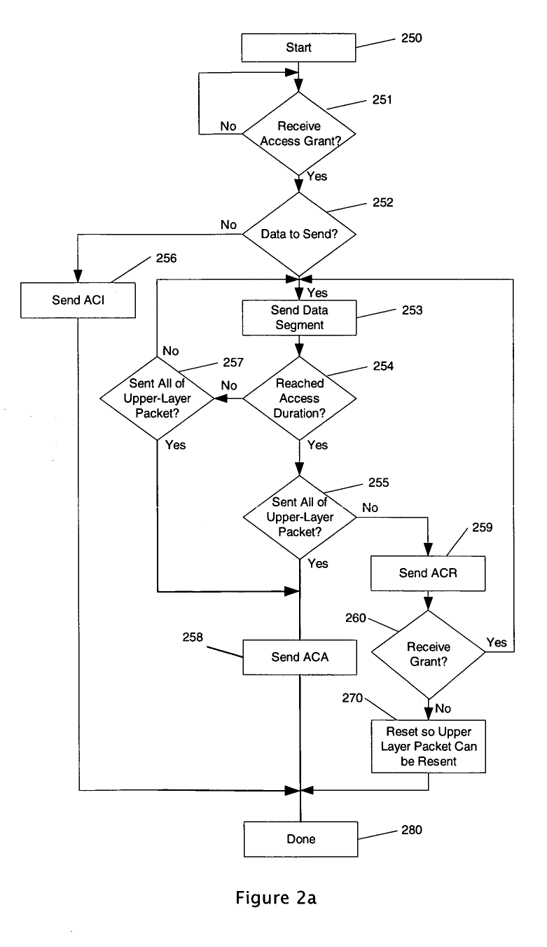

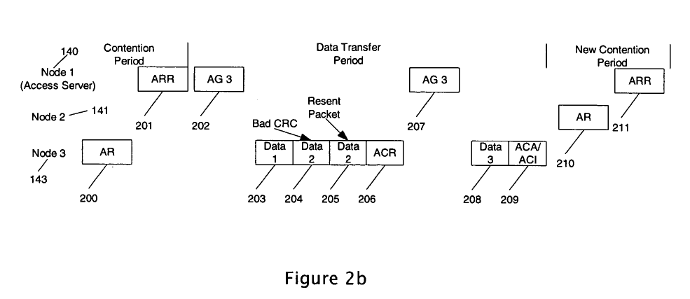

FIG. 2a is a flow diagram of the present preferred method of a node being granted access and sending data. The process begins 250 with the network node 141 waiting 251 to receive an access grant. Once an access grant is received, the process checks 252 to see if there is data to send. If not, the process sends 256 an ACI packet which indicates to the access server 140 that the network node 141 has no data to send and the process ends 280. Otherwise if there is data to send 252 the process sends 253 a data segment. The process checks 252 to see if the process has reached the access duration value 254. The access duration value gets incremented for each segment sent. If the access duration value has not been reached, the process checks 257 to see if the entire upper layer packet has been sent. If not, the process sends the next segment 253. Otherwise, the process sends 258 an ACA packet to indicate that network node 141 is done sending data and the process ends 280. If in test 254 the access duration has been reached, the process checks 255 to see if the entire upper layer packet has been sent. If so, an ACA packet is sent 258 and the process completes 280. Otherwise, an ACR packet is sent 259 which indicates that part of the upper layer packet still needs to be sent. Test 260 checks to see if an access grant is received in the next grant period. If so, the next segment is sent 253. Otherwise, the process resets 270 so the full upper layer packet can be resent the next time the network node 141 get access and the process complete 280.

FIG. 2b is a packet diagram of the present preferred access request and granting process when an upper layer packet is not sent completely during an access period. Large upper layer packets are broken up into smaller packets called segments. The contention period is resolved the same as before 200-201 and the access server 140 grants access with an Access Grant packet 202 to network node three 143. Network node three 143 sends the first data segment 203 which is sent successfully with a valid CRC. The second segment 204 has a bad CRC and is resent in 205. At this point the network node three 143 cannot send any more segments because its access duration value only allowed the process to send three segments. The upper layer packet still requires three segments to complete the packet. Network node three 143 sends an Access Continue Request 206 which tells the access server 140 that the process has not sent all the data in the upper layer packet. The access server grants 140 access 207 to node three 143. Network node three 143 sends the rest of the upper layer packet in the third segment 208 and sends the either the ACA or ACI packet 209, which starts a new contention period 210-211. This way the complete upper layer packet is sent and the receiving node is only processing a single upper layer packet at a time. The access server 140 monitors the network 142 for the ACA, ACI or ACR packet during the token grant period. If the access server 140 does not see either of these packets, the access server 140 sends an ACI packet so other nodes know that a contention period is about to begin. If the ACR packet was lost, the receiving node can start receiving segments from another node before receiving the entire previous packet. Since it is easier for a network node 141 to only process one upper layer packet at a time, the network node 141 will drop the previous upper layers packet's segments and process the new upper layer packet. The node that sent the previous upper layer packet can decide if it wants to resend the upper layer packet.

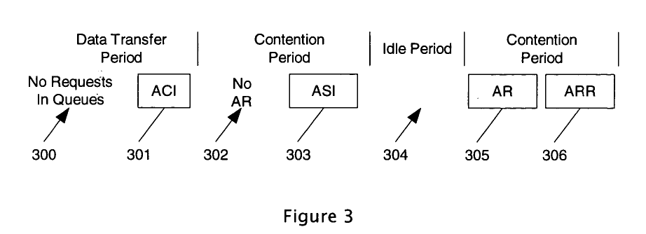

FIG. 3 is a packet diagram of the preferred process for an access server going inactive and active based on access requests. If there are no requests 300 for access in the request queues 416 and 417, the access server sends an Access Complete Inactive packet 301 to signal other network nodes 141, 143 nodes that a new contention period is beginning. This can be due to a lost packet, other error conditions, or no nodes requiring access to the network 142 or the like. If none of the network nodes 141 or 143 on the network 142 respond with an Access Request 302, the access server 140 responds with an Access Server Inactive packet 303 which tells all nodes on the network 142 that the access server 140 is going into an idle state. The idle period 304 is a period of time where the access server 140 waits for an Access Requests 305 which starts a new contention period. The access server 140 responds with an Access Request Response packet 306 to begin a new grant period. If a network node 141, 143 does not get a response to an access request, the network node 141 can if it is capable, become an access server, thus allowing for fault tolerance and redundancy. On a peer channel, any node can become the access server, while on a control node channel; only the control node can be the access server.

As network nodes 140, 141, 143 request access to the network 142 by sending an Access Request packet, there are four parameters that the node sets which determines how often, at what priority, and how much data a node can send. The parameters are as follows: 1. Which Queue 416, 417 (High or Low) 2. Queue Priority (Used to determine which requests get added and removed from each queue) 3. Time to Live (How long between data sends before a request is removed from a queue) 4. Access Duration (How much can be sent when a node has the access) FIG. 4a is a diagram of the preferred request queue prioritization method used for granting access to the channel. Access is controlled by two queues: 1) High priority 416 and 2) Low priority 417. Each queue is a circular queue in which each request in the queue is processed in a round-robin fashion. Both the high queue 417 and the low queue contain eight requests slots 400-407 and 408-415. In the preferred embodiment, the size of each queue is defined dynamically. FIG. 4 represents an example of a queue size that can contain up to eight requests. Queue size can vary based on system resources such as memory, processor, cost, speed, and the like. As requests for access are received by the access server 140, they are placed in corresponding queue 416 or 417. In the preferred embodiment, the queue priority can be any value from zero to fifteen (fifteen being the highest priority). For example, if the queue 416 or 417 is full and the lowest request in the queue is at a priority of two; a new request with a priority of three would displace the lower priority request. The access server 140 goes through the high priority queue 416 a defined number of times (unless there are no requests in the queue) and services requests in the low priority queue 417.

FIG. 4b is a flow diagram of the present preferred method for determining which request will be serviced. FIG. 4b is a detailed flow diagram of step 158. The process begins 450 when it is time to determine which network node 140, 141, 143 will be granted access. Test 451 checks to see if the high queue 416 slot number is equal to eight. If the value is eight it means that all the slots have been serviced. If the value is not eight test 452 checks to see if the current slot being pointed to is free. If so, the high queue 416 slot number is incremented 453. Test 454 checks to see if the queue number equals the saved number. Test 454 checks to see if we have serviced all eight slots in this grant period. If the numbers are not equal, the process checks 451 the high queue 416 slot number. Otherwise, if test 454 is yes, the process saves 457 the current high queue slot number and completes 458. If the slot is not free in test 452, access is granted 455 to the network node 141 in the high queue 416. The high queue 416 slot count is incremented 456 and saved 457. The process completes 458. If test 451 determines that the slot number is equal to eight, the high queue 416 slot number is set 459 to zero. The process checks 462 to see if the low queue 417 slot number is equal to seven. If so, the process resets 460 the low queue 417 slot number and checks 451 the high queue 416 slot number. Otherwise, if the low queue 417 slot number is not seven 462, the process checks 463 to see if the slot is free. If so, the process increments 461 the low queue 417 slot count and checks 462 if the slot count is equal to seven. If the slot is not free 463, access is granted 464 to the network node 141 in the queue. The current low queue 417 slot number is incremented 465 and the process completes 458.

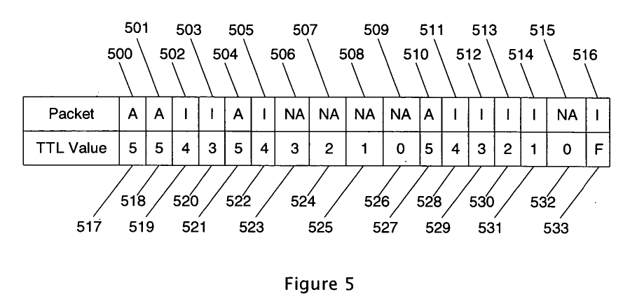

The Time To Live (TTL) value is used to determine how long a network node's 141 request for access will stay in the queue. In the preferred embodiment, the TTL value is based on the frame time of approximately 9.9 ms (37 frames), but can be based on other time values. A frame is a periodic time period for sending data across a network 142. In the preferred embodiment, the TTL value is a 10-bit value, but can be a different size if necessary. The TTL value gets decremented when a network node 141 has not sent data during a data transfer period. Once a network node 141 has sent data, the value is set back to its original value. FIG. 5 is a diagram of the preferred relationship between packets received by the access server 140 and a network node's 141 time to live value. The values in the packet field of FIG. 5 are defined as follows: A=ACA Packet I=ACI Packet NA=Access was not granted during the period F=AGF Packet. FIG. 5 is an example how an access server calculates the TTL value for a node where the TTL value starts at five. After a network node 141 has been granted access and sends data, the network node 141 sends an ACA packet 500-501, the TTL value for that node stays at five 517-518. When the network node 141 responds with an ACI packet 502-503 indicating that the network node 141 has no data to send the TTL value is decremented by one each time 519-520. If the network node 141 has data to send, the network node 141 will be granted access when the network node 141 sends an ACA packet 504, the TTL value gets reset back up to five 521. As the network node 141 has no data to send and responds to the access request with an ACI 505, the TTL value is again decremented by one 522. When the network node 141 is not granted access because another network node 143 has gained access 506-509, the TTL value is also decremented by one for each access period 523-526. When the TTL value reaches zero, this signifies that on the next access the network node 141 will be removed from the access queue 416 or 417 if the network node 141 has no more data to send. The network node 141 must re-request access to the queue 416 or 417 in order to send data. In this example, the network node 141 has data to send and sends an ACA packet 510. The TTL value is set back to five 527. The network node 141 has no more data to send so the network node 141 sends an ACI packet for each access grant 511-514. The TTL value is decremented each time 528-531. Another network node gains access 143 and sends data 515 which causes the TTL value to go to zero 532. The network node 141 still does not have data to send during the next access and sends an ACI packet 516. The access server 140 responds with an Access Grant Final (AGF) packet telling the network node 141 it has been removed from the queue 416 or 417. The network node 141 must re-request access to the queue before the network node can send data again.

The access duration value tells a network node 140, 141, 143 how many packets or how long the network node 140, 141, 143 can send data before the network node 140, 141, 143 must send an ACA packet to start a new contention period. The larger this value is the more data the network node 140, 141, 143 can send during the data transfer period. In the preferred embodiment, the access duration value is a 10 bit value which is tied to a periodic time period.

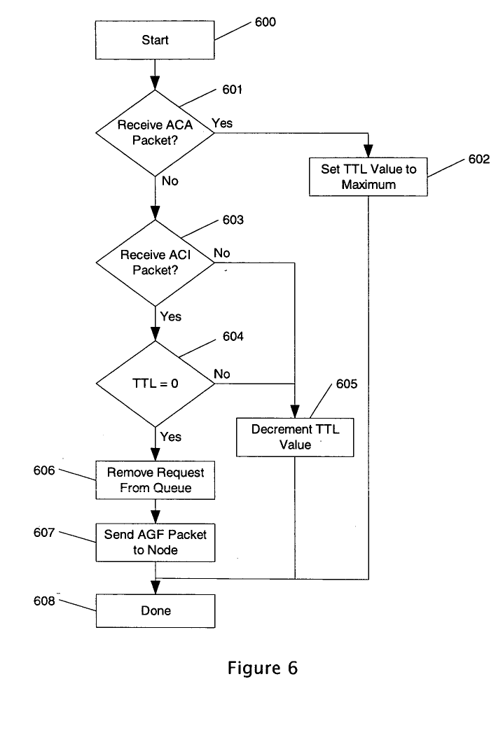

FIG. 6 is a flow diagram of the present preferred time to live algorithm. The process begins 600 and the access server 140 checks 601 if an ACA packet has been received from the network node 141 it is servicing. If so, the TTL value for that network node 141 is set 602 to the maximum and the process completes 608. Otherwise, if the access server 140 did not receive 601 an ACA packet, the access server 140 checks 603 to see if the access server 140 received an ACI packet. If not, the TTL value is decremented 605 and the process completes 608. Not receiving an ACA or ACI packet from the network node 141 indicates that another network node 143 had access or none of the network nodes 140, 141, or 143 had access. If the TTL value equals zero in test 604, the access server 140 removes 606 the request from the queue 416 or 417. The access server 140 sends 607 an AGF packet to the network node 141 and the process completes 608.

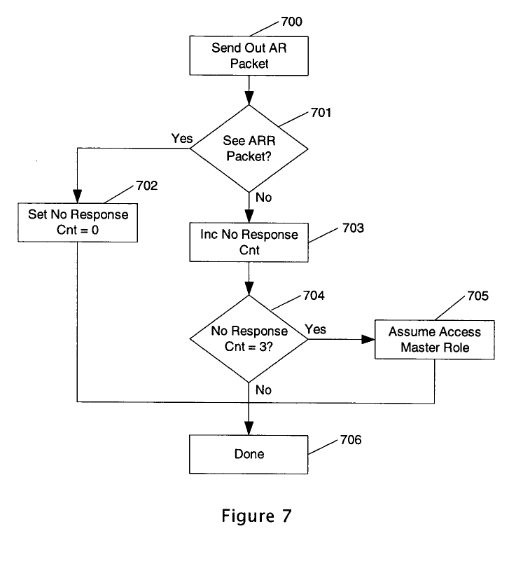

FIG. 7 is a flow diagram of the present preferred method for a network node 141 becoming an access server. The process begins by a network node 141 sending out an AR packet 700. The network node 141 checks 701 to see if the network node 141 received an ARR packet. If so, the no response count is set 702 to zero. Otherwise, the no response count is incremented 703. Test 704 checks to see if the response count is three. If so, the network node 141 assumes the role 705 of access server 140 and the process completes 706. If in test 704 the response count is less than three, the process completes 706. The response count is not limited to three, but can be changed as the system requires.

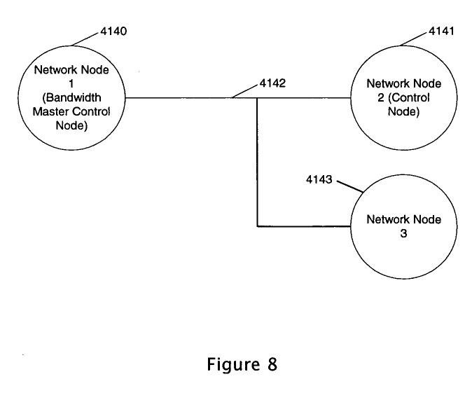

FIG. 8 is a diagram of the present preferred network for sending data segments between network nodes. In this document when referring to a network node in the singular, while referencing the single node with multiple nodes indicates that all referenced nodes can perform the same function as the single network node. A network 4142 is formed by plurality network nodes 4140 and 4141. One of the network nodes 4140 is a bandwidth master control node. Segments (packets) are sent across a time division multiplexed data mechanism which includes network 4142 which further includes time slots 4120-4136.

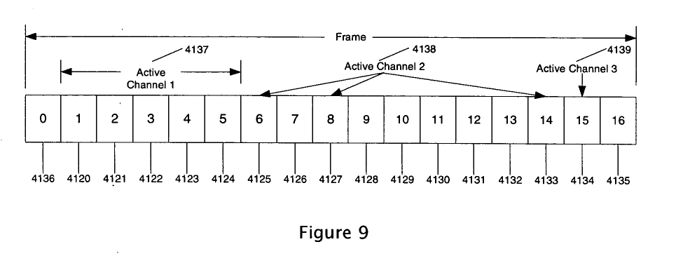

FIG. 9 is a diagram of the time division multiplexed data transfer mechanism of the present preferred embodiment of this invention used to transfer data on a network 4142. Transfer of data across a network 4142 occurs in two forms: packets which are broken up into segments and non-packet. Examples of data include but are not limited to voice, audio, control, video, and computer information and the like. A frame represents the bandwidth of the network 4142 over time and consists of a plurality of time slots 4120-4136. Time slots 4120-4136 in the present preferred embodiment are equal size pieces of Time Division Multiplexed (TDM) bandwidth which is used to transfer data over the AC power line or network 142. Each time slot is presently is 10 bits wide. The actual data sent presently is 32 bits with 22 bits used for forward error correction which results in 10 bits for each time slot. This is a 5/16 rate code. Time slot 4136 is used for frame synchronization across the network 4142 and time slots 4120-4135 are used for data transfer. Data is sent using active channels 4137-4139, which are pieces of network 4142 bandwidth. An active channel 4137-4139 is a variable or fixed size pipe made up of a single time slot or a plurality of time slots used to form a packet or non-packet pipe. For example, an active channel 4137 can be but is not limited to a group of contiguous slots 4120-4124. On the other hand, an active channel 4138 can consist of noncontiguous slots 4126, 4128, 4133. In addition, an active channel 4139 can include a single time slot 4134 or any number of time slots up to the maximum number of time slots in the frame. An active channel 4137-4139 is created by a bandwidth master control node 4140 which is a network node responsible for creating active channels 4137, 4138, and 4139 in conjunction with network nodes 4140, 4141, 4143 on a network 4142. Any network node can assume the role of bandwidth master control node 4140.

To transfer data between nodes, the user or application creates a Virtual Channel (VC) and creates an Active Channel (AC) 4137-4139. However, the virtual channel is not necessary if an active channel 4137-4139 does not need to be persistent. A virtual channel is a grouping of devices that eventually need to communicate with each other and can use the same service type. A service type is unique identifier that represents the type of data being transferred across a network 4142. Virtual channels contain persistent information about how to setup an active channel 4137-4139 when bandwidth is needed. Active channels 4137-4139 are created and destroyed by a network node 4140 that is responsible for bandwidth allocation called a bandwidth master control node 4140. A bandwidth master control node 4140 can control but is not limited to one or more distinct networks 4142 using the same physical medium by using a network number to identify each network 4142. An active channel 4139 is instantiated when a network node 4141 responsible for the active channel 4139 needs to create an active channel 4139, to pass data between network nodes 4140, 4141, 4143 in a active channel 4139. An active channel 4139 will typically exist only as long as the network nodes 4140, 4141 need bandwidth to transfer data while a virtual channel can exists permanently (or until the user or application no longer needs it). On the other hand, an active channel may stay up permanently if necessary. Virtual channels and active channels 4137-4139 are created via a signaling channel (which is an active channel) which is used to exchange information between nodes.

Once the network 4142 is created, virtual channels can be created. For example, virtual channels can be created for, but are not necessarily limited to Internet connections, alarm systems, appliances, home control systems, stereo systems, voice systems, and the like. This can occur from, but is not limited to an administrative console or an application going out and identifying which network nodes 4140, 4141 need to be apart of the virtual channel. A Virtual Channel Structure (VCS) is created which contains all the information necessary to create an active channel 4139. This allows network nodes 4140, 4141, 4143 to recreate an active channel 4139 that existed when power was lost on the network 4142. The virtual channel structure also keeps the network 4142 and the active channel 4139 secure by storing the encryption key information. The process is the same whether new network node 4141, 4142, 4143 is being added to an existing virtual channel or creating a new virtual channel.

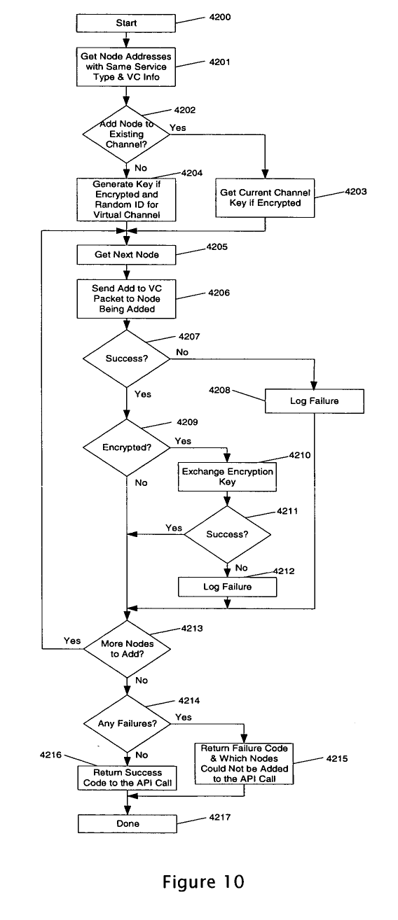

FIG. 10 is a flow diagram of the preferred virtual channel creation process from a network node 4141 which is requesting to create a virtual channel 4139. A request is made 4200 to create a virtual channel. The user or application generates 4201 a list of network nodes 4140, 4141, 4143 and the service type that are part of the virtual channel. This coupled with a virtual channel name is used to create an active channel 4139. At test 4202 the network node 4141 checks to see if an active channel 4139 already exists. If so, the application goes out and gets 4203 the existing encryption key for the virtual channel. Otherwise, the application generates 4204 a random key and ID for the virtual channel. The virtual channel name and the random ID are used to uniquely identify a virtual channel. In order to create a virtual channel, all network nodes 4140, 4141, 4143 that are part of the virtual channel should be able to communicate on the network 4142 or at a later period in time if being added to the virtual channel. If a network node 4140, 4141, 4143 was not a part of the initial virtual channel creation the network node 4140, 4141, 4143 will have to be added by a network node 4140, 4141, or 4143 that is already apart of the virtual channel in order to have a secure network. After getting 4205 the next network node 4140, 4141, or 4141 to be added, the packet to add the next node to the VC is sent 4206. The packet contains the virtual channel information except the encryption key. If test 4207 is not successful, an error is logged 4208. If test 4207 is successful, and if the active channel 4139 is to be encrypted 4209, the encryption key is passed 4210 using an encryption key passing algorithm. The present preferred embodiment uses Diffie-Hellman key exchange, but a variety of key exchange methods can be used. The encryption key is exchanged 4210. If test 4211 is successful, the process continues to see if more network nodes 4140, 4141, 4143 are to be added 4213. Otherwise, an error is logged 4212 for that network node 4140, 4141 or 4143. Test 4213 checks to see if there are other network nodes 4140, 4141 or 4143 to be added to the virtual channel. If so the process gets 4205 to be added to the virtual channel. Otherwise, there is a check 4214 for any failures. If there were any failures logged in step 4212, they are passed 4215 back to the Application Programming Interface (API). Each network node 4140, 4141, 4143 that failed to be added to the virtual channel and the reason why there was a failure is passed back 4215 to the API. If there were not any failures in test 4214, success is returned 4216 to the API. The process completes 4217.

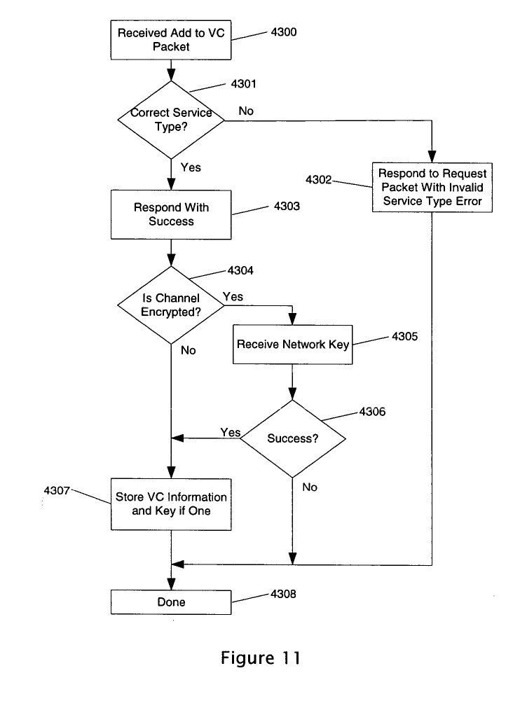

FIG. 11 is a flow diagram of the present preferred virtual channel creation process from the network node 4140, 4141, 4143 which is being requested to be apart of the virtual channel, wherein FIG. 10 is the flow diagram from the node creating the virtual channel. When a network node 4140, 4141, 4143 receives 4300 an “add to virtual channel packet”, the network node 4140, 4141, 4143 checks 4301 the service type to make sure that the service type matches its own service type. If there is not a match, the network node 4140, 4141, 4143 responds 4302 with an error packet. If there is a match in test 4301, the process responds 4303 with a success in the packet status. If the active channel 4139 is supposed to be encrypted in test 4304, the encryption key exchange process is used 4305 to exchange the virtual channel encryption key. If successful in test 4306, the key and the virtual channel information are stored 4307 and the process completes 4308. If the encryption key exchange fails in test 4306, the process completes 4308.

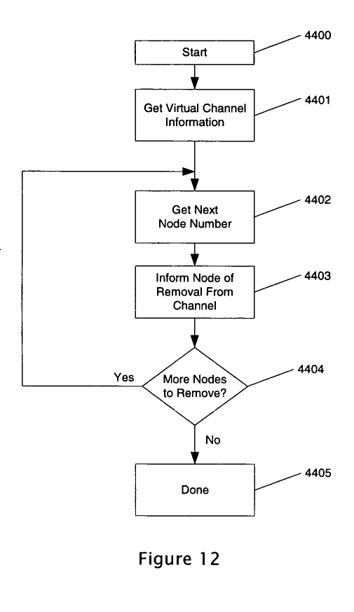

FIG. 12 is a flow diagram of the present preferred virtual channel removal process once an active channel 4139 is created. Under user or application control, a virtual channel can also be removed. Once the process is started 4400, a network node 4140, 4141, 4143 gets 4401 the virtual channel information. The algorithm goes through 4402 each network node that is part of the virtual channel 4140, 4141, 4143 in the list of network nodes 4140, 4141, 4143 and informs each network node 4140, 4141 or 4143 that is the network node 4140, 4141 or 4143 is being removed from the virtual channel at block 4403. The network node 4140, 4141 or 4143 deletes the virtual channel information. This process tests 4404 the next network node 4140, 4141, 4143 on the active channel 4139. If there is another network node 4140 or 4141 in test 4404, the process gets 4402 the next network node number. Otherwise, the process completes 4405. If a network node 4140, 4141 or 4143 cannot respond, the network node 4140, 4141, 4143 can to be removed later using the same process.

In the present preferred embodiment, here are two types of active channels that can be created: A control node active channel, and a peer active channel. A control node active channel is an active channel 4139 where there is one network node 4141 called a control node 4141 responsible for setting up and controlling an active channel 4139. A peer active channel is where network nodes 4140, 4141 can come and go and there is no central control node 4140, 4141 or 4143 responsible for creating an active channel 4139. The control node responsible for a control node active channel or any node responsible for a peer active channel can be any network node 4140 or 4141 on the network 4142 including the bandwidth master control node 4140. In a control node active channel, there is one network node 4141 that is responsible for creating, adding nodes to, and deleting nodes from an active channel 4139. If the control node 4141 is not active, the active channel 4139 cannot be established.

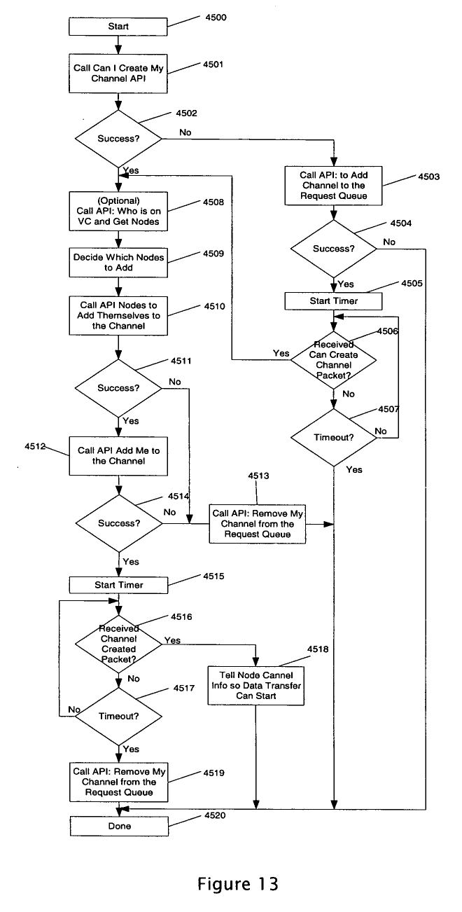

FIG. 13 is a flow diagram of the present preferred control node active channel creation process. First, the application starts 4500 by calling 4501 the “Can I Create My Channel” application programming interface that sends a packet to the bandwidth master control node 4140. The bandwidth master control node 4140 is responsible for creating virtual channels. If the response was not successful in test 4502 and the network node 4140, 4141, 4143 still wants the active channel 4139 to be created when resources are available, the network node 4140, 4141 or 4143 calls 4503 the application programming interface “Add Me to the Channel.” This application programming interface call puts the request into the request queue so that the bandwidth master control node 4140 can tell the network node 4140, 4141 or 4143 when an active channel 4139 can be created. If this successful in test 4504, a timer is started 4505 and the bandwidth master control node 4140 looks 4506 for the “You Can Create Your Channel” packet. If this packet is received the creation process optionally calls 4508 the API “who is on VC and get nodes.” Otherwise, the process times out 4507 and completes 4520. Once the network node 4140, 4141, or 4143 is informed that the active channel 4139 can be created in test 4502 or test 4506, the network node 4140, 4141, or 4143 goes and determines 4508 which network nodes 4140, 4141, or 4143 are on the active channel 4139 if the network node 4140, 4141, 4143 doesn't know already. The network node 4140, 4141, 4143 decides 4509 which network nodes 4140, 4141, 4143 need to be apart of the active channel 4139 if the network node 4140 or 4141 did not know earlier. The application calls 4510 the Application Programming Interface to Tell a Node to Add Itself to the Channel. When a network node 4140, 4141, 4143 receives a request to add the network node 4140, 4141 or 4143 to an active channel 4139, the network node 4140, 4141, or 4143 informs the bandwidth master control node 4140 and requests that the network node 4140, 4141 or 4143 be added to the active channel 4139. If this is successful, the process responds 4510 to the Tell a Node to Add Itself to the Channel message. If test 4511 was not successful, the control node 4141 calls 4513 the “Remove My Channel from the Request Queue” application programming interface which ends the Active Channel creation. Otherwise, the control node 4141 will add 4512 the control node 4141 to the active channel 4139. If there is a failure in test 4514, the control node 4141 calls 4513 the “Remove My Channel from the Request Queue” application programming interface. Otherwise, the control node 4141 starts 4515 a timer and waits for the packet that indicates that the active channel 4139 was created. Once control node 4141 receives 4516 the packet that indicates the active channel 4139 was created, the control node 4141 tells 4518 all the network nodes 4140, 4141, 4143 using the active channel 4139 the information necessary to use the active channel 4139 and completes the process 4520. If the timer expires in test 4517, the control node 4141 calls 4519 the “Remove My Channel from the Request Queue” application programming interface to remove the request and the process completes 4520.

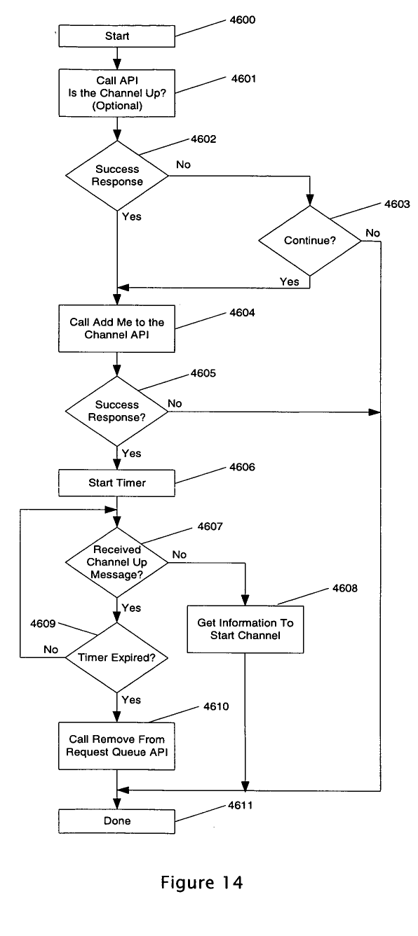

For peer networks, the process happens differently. This is because in a peer network, any network node 4140 or group of network nodes 4140, 4141, 4143 can be up at any time. For this reason, any network node 4140, 4141, 4143 can initiate the process that creates an active channel 4139. A network node 4140, 4141 or 4143 can request to be added to an active channel 4139, but an active channel 4139 will not be created until at least two network nodes 4140, 4141 have requested to be added to the active channel 4139. FIG. 14 is a flow diagram of the present preferred active channel 4139 creation process for a peer active channel. On a peer active channel, a network node 4140 or 4141 can optionally go out 4600 and see if the active channel 4139 is up 4601. In test 4602 if the response is unsuccessful, the network node 4140, 4141, 4143 can decide if the network node 4140, 4141, 4143 wants to continue in test 4603 or quit. If the network node 4140, 4141, 4143 wants to quit, the process completes 4611. If the network node 4140, 4141, 4143 wants to continue, network node 4140, 4141, 4143 calls 4604 the Application Programming Interface Add Me to a Channel. Step 4604 is also called if test 4602 is successful. If test 4605 is unsuccessful the process completes 4611. Otherwise, if test 4605 is successful, the network node 4140, 4141 or 4143 starts a timer 4606 in which the network node 4140, 4141 or 4143 looks 4607 for the channel is up packet. If the network node 4140, 4141, 4143 receives this message the network node 4140, 4141, 4143 joins 4608 the active channel 4139 and the process completes 4611. Otherwise, if there is a timeout 4609, the network node 4140, 4141, 4143 removes 4610 the network node's 4140, 4141, 4143 request to be added from the request queue and ends the process 4611. This process works the same for a network node 4140, 4141 or 4143 being added after an active channel 4139 is up. To remove an active channel 4139, a network node 4140, 4141 or 4143 can call the remove a channel API. The bandwidth master control node 4140 will inform each network node 4140, 4141, 4143 that is currently apart of the active channel 4139 that the active channel 4139 is being torn down.

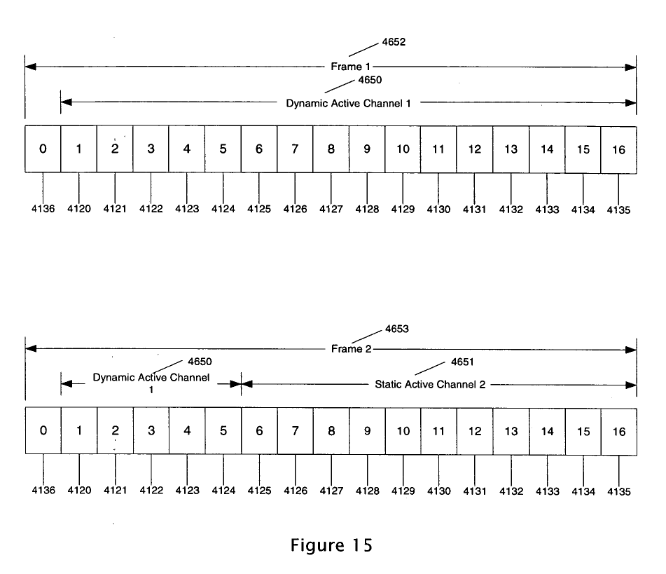

FIG. 15 is a diagram of the present preferred dynamic active channel resizing. When a dynamic active channel 4650 is created, there are two fields: The minimum bandwidth value and maximum bandwidth value. These fields are used by the bandwidth master control node 4140 to create dynamic active channels 4650 that can be increased or decreased based on available bandwidth. Active channels can be either static active channels 4651 or dynamic active channels 4650. A dynamic active channel 4650 is one where the dynamic active channel's 4650 size (the number of time slots 4120-4135 the active channel 4650 uses) can change dynamically and a static active channel 4651 will always require the same number of time slots 4125-4135 in this example. FIG. 15 depicts a static active channel 4651 that uses 11 time slots 4125-4135. The size of a static active channel 4651 can be any size from one time slot to the maximum number of time slots 4120-4135 that the system uses. A dynamic active channel 4650 can be resized on the fly down to the minimum bandwidth value or up to the maximum bandwidth value. The minimum bandwidth field and maximum bandwidth fields will be the same for a static active channel 4651. These fields are coupled with the bandwidth priority value are used to track the priority of the dynamic active channel 4650 or static active channel 4651 and whether the channel is a static active channel 4651 or a dynamic active channel 4650. The preferred embodiment uses the following four priorities: 1. Guaranteed Priority, 2. High Priority, 3. Normal Priority, and 4. Low Priority. Bandwidth is allocated on a priority basis, thus allowing a higher priority dynamic active channels 4650 or static active channels 4651 to take bandwidth from lower priority channels. When a dynamic active channel 4650 is first created the dynamic active channel 4650 takes all free time slots up to the maximum bandwidth value. Dynamic active channel one 4650 has a minimum bandwidth value of one and a maximum bandwidth value of fifteen. Frame one 4652 shows dynamic channel one 4650 taking all time slots 4120-4135 when dynamic active channel one 4650 is first created on an unused network 4142. When a new channel is created (static or dynamic) bandwidth is taken from dynamic channels 4650. For example, if after dynamic active channel one 4650 is created, the dynamic active channel one 4650 is dropped in frame two 4653 to 5 time slots 4120-4124 as a new static active channel one 4651 is created even if static active channel one 4651 is a lower priority. The minimum bandwidth value and the maximum bandwidth values are only limited by the number of time slots 4120-4135 available. Once there are no dynamic slots available, active channels are created or deleted based on priority. Priority is not limited to but in the present preferred embodiment is on a first come first serve basis. This means that a new active channel cannot be created if all the slots are allocated by active channels at the same or higher priority.

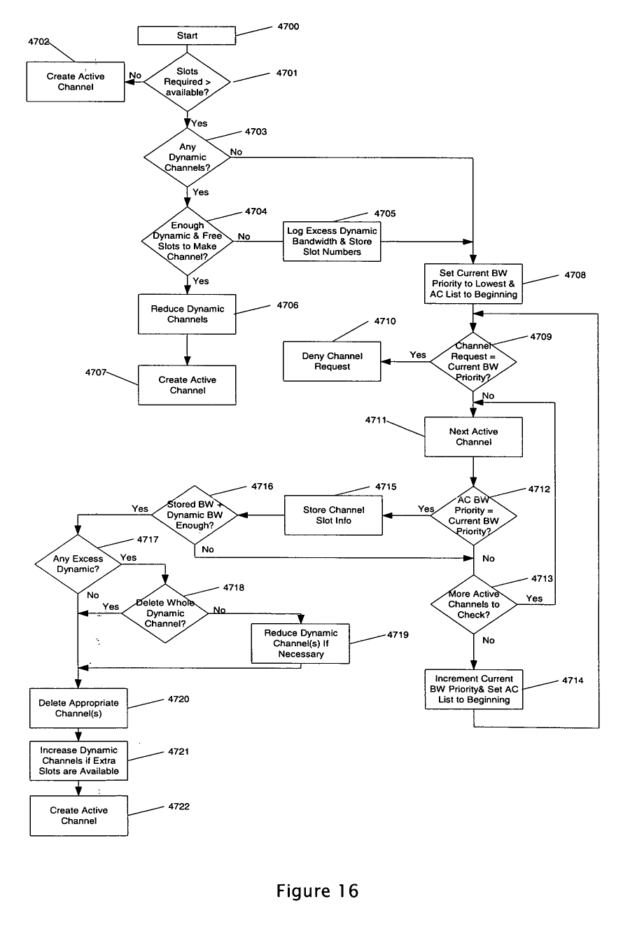

FIG. 16 is a flow diagram of the preferred process for bandwidth allocation using channel priorities. Once a new active channel 4651 needs to be created 4700, the bandwidth master control node 4140 first looks 4701 to see if there are enough free time slots 4120-4135 to create the new active channel 4651. An active channel 4651 will be created if there are at least enough free time slots 4120-4135 to meet the minimum bandwidth value. If so, the new active channel 4651 is created 4702. Otherwise, the bandwidth master control node 4140 looks 4703 to see if there are any dynamic active channels 4650. The process checks 4704 to see if there are enough dynamic and free time slots 4120-4135 to create the new active channel 4651. If the process determines that the dynamic channels 4650 have enough excess bandwidth (the difference between the minimum bandwidth value and the current size of the dynamic active channel 4650) to create the new active channel 4651, the dynamic active channel(s) 4650 size is reduced 4706 and the new active channel 4651 is created 4707. If the time slots 4120-4125 to create the new active channel 4651 are coming from multiple dynamic active channels 4650, the time slots 4120-4135 used come from the lowest priority dynamic active channel 4650 first in the present preferred embodiment. If the active channels are at the same priority, the process is done (but not required to) on a first come first serve basis. If there are not enough excess dynamic time slots 4120-4135 available 4704, the time slots 4120-4135 are logged 4705 and stored for use later. If there is not enough bandwidth at steps 4703 or 4705, the current bandwidth priority value is set 4708 to the lowest priority. The current bandwidth priority value is used to search through the active channel list for priorities that match it. The active channel list is set 4708 to point to the beginning of the list of active channels. The request to build the new active channel 4651 is checked 4709 to see if the new active channel 4651 is at the current search bandwidth priority. If so, a deny channel packet is sent 4710 to the control node 4141 and the process ends. Otherwise, the channel search process continues by getting 4711 the next active channel from the list. The current active channel's bandwidth priority is compared 4712 to the current search bandwidth priority. If a match is not found, the process tests 4713 to see if there are more active channels in the list. If there are more active channels in the list to check 4713, the process gets the next active channel in the list 4711. Otherwise if test 4713 is no, the active channel list search pointer is set 4714 back to the beginning, the current bandwidth priority is incremented, and the process checks to see if the new channel request is equal 4709 to the current bandwidth priority. When an active channel is found that is at a lower bandwidth priority than the new active channel 4651 and is at the current search bandwidth priority in test 4712, the information is stored 4715. This information along with the slot information of any excess dynamic channel slots 4120-4135 from step 4705 and any previous lower priority time slots 4120-4135 are checked 4716 to see if there are enough time slots 4120-4135 to make the new active channel 4651. If not, the process returns to the channel search process and checks 4713 to see if there are more active channels in the list. Otherwise, the process of creating the new active channel 4651 begins. If there are excess dynamic slots available 4717, the bandwidth master control node 4140 checks to see if the whole dynamic active channel 4650 to which the excess dynamic time slots 4120-4135 are tied needs to be deleted 4718. If not, the dynamic active channel's 4650 size is reduced 4719 if necessary. It may not be necessary to reduce the active dynamic channel 4650 if the excess dynamic time slots 4120-4135 are not great enough to be used in the new active channel 4651 in step 4719. The necessary channel or channels are deleted 4720. If there are any excess slots that can be used in dynamic channels 4650, the excess slots are reassigned 4721 to the appropriate channel or channels. Finally, the new active channel 4650 is created 4722.

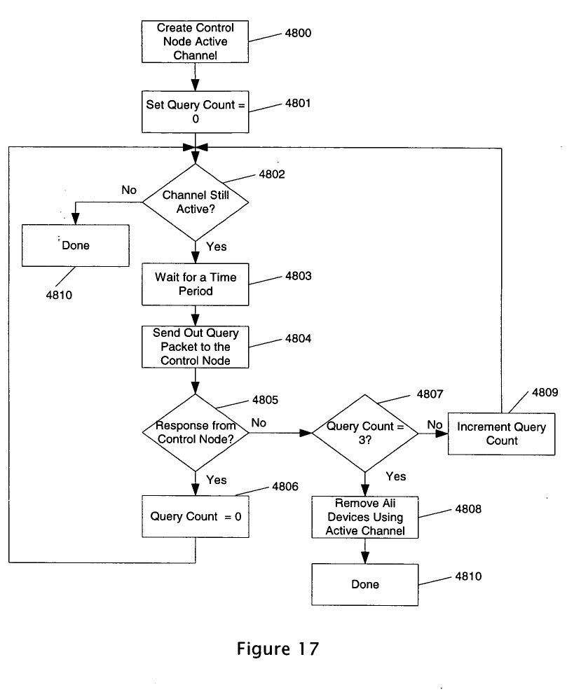

FIG. 17 is a flow diagram of the present preferred process for bandwidth reclamation in a control node active channel. The process begins when a control node active channel is created 4800 on the bandwidth master control node 4140. The control node active channel has a control node 4141 and a network node 4143 that use the control node active channel. The query count is then set 4801 to zero. The process then tests 4802 to see if the control node active channel is still active. If not the process is done 4810. Otherwise, if the control node active channel is still active 4802, the process waits 4803 for a period of time. The process sends 4804 out a query packet to the control node 4141. If a response to the query packet is received in test 4805 from the control node 4141, the query count is set 4806 to zero and the process tests 4802 to see if the control node active channel is still active. Otherwise, if there is no response from the control node 4141 in test 4805, the query count is checked 4807 to see if it is three. In the present preferred embodiment, the query count is three, but this value could be dynamic or another value as the needs of the system require. If the query count is three 4807, all network nodes 4141, 4143 using the control node active channel are removed 4808 from the control node active channel by sending remove from channel packets to each network node using the control node active channel and the process is done 4810. Otherwise, if the query count is not three in test 4807, the process increments 4809 the query count and checks 4802 to see if the control node active channel is still active.

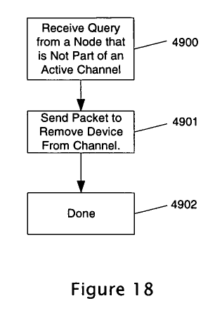

FIG. 18 is a flow diagram of the present preferred process for notifying network nodes that the network node is no longer part of an active channel. When a control node 4141 or a network node 4143 cannot see query packets from the bandwidth control node master 4140 for reasons such as network noise and the like, these network nodes may have been removed from an active channel without being informed. If a network node 4141, 4143 cannot see the bandwidth master control node 4140; the network nodes 4141, 4143 send query packets to the bandwidth master control node 4140. If the bandwidth master control node 4140 receives 4900 a query from a network node 4140 or a control node 4141 and that node is no longer apart of the active channel associated with the query, the bandwidth master control node 4140 will then send 4901 a packet to remove network node 4140 or 4141 from the active channel. The process is then done 4902.

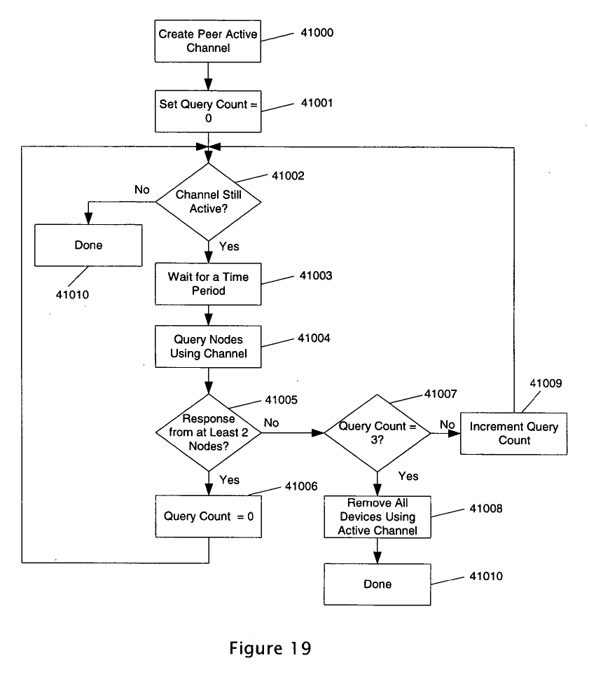

FIG. 19 is a diagram of the present preferred process for bandwidth reclamation in a peer active channel. The process begins when a peer active channel is created 41000 on the bandwidth master control node 4140 where the peer channel has two network nodes 4141, 4143 that use the peer channel. The query count is then set 41001 to zero. The process then tests 41002 to see if the peer active channel is still active. If not the process is done 41010. Otherwise, if the peer active channel is still active 41002, the process waits 41003 for a period of time. The process sends 41004 out query packets to network nodes 4141, 4143 on the peer active channel until at least two network nodes 4141, 4143 respond or all network nodes have been queried. If a response to at least two of the query packets is received in test 41005, the query count is set 41006 to zero and the process tests 41002 to see if the peer active channel is still active. Otherwise, if there is no response from at least two network nodes 4141 and 4143 in test 41005, the query count is checked 41007 to see if it is three. In the present preferred embodiment, the query count is three, but this value could be dynamic or another value as the needs of the system require. If the query count is three 41007, all the network nodes 4141, 4143 using the peer active channel are removed 41008 from the peer active channel by sending remove from channel packets to each network node 4141, 4143 using the peer active channel and the process is done 41010. Otherwise, if the query count is not three in test 41007, the process increments 41009 the query count and checks 41002 to see if the peer active channel is still active.

These network access and granting methods are designed so that they will run over a variety of networks, but are not limited to such types of networks as AC power line, DC power line, light frequency (fiber, light, and the like), Radio Frequency (RF) networks (wireless such as 802.11b, infrared, and the like.), acoustic and wired (coax, twisted pair, and the like.).

In addition, these data transportation methods can be implemented using a variety of processes, but are not limited to computer hardware, microcode, firmware, software, and the like.

The described embodiment of this invention is to be considered in all respects only as illustrative and not as restrictive. Although specific flow diagrams and packet formats are provided, the invention is not limited thereto. The scope of this invention is, therefore, indicated by the claims rather than the foregoing description. All changes, which come within the meaning and range of equivalency of the claims, are to be embraced within their scope.

1. A system for requesting access to a network comprising:
A. a plurality of network nodes forming a network;
B. wherein said plurality of network nodes further comprises an access server;
C. wherein said network further comprises one or more active channels having a plurality of time slots; and
D. wherein said network nodes request access from said access server for said one or more active channels.

2. A system for requesting access to a network as recited in claim 1, wherein said network is selected from the group consisting of a wireless network, a light frequency network, a power line network, an acoustic network, and a wired network.

3. A system for requesting access to a network as recited in claim 1, wherein at least one of said network nodes requests access during a contention period.

4. A system for requesting access to a network as recited in claim 3, wherein at least one of said network nodes requests access during said contention period marked by a packet.

5. A system for requesting access to a network as recited in claim 1, wherein said network nodes request access by specifying one of the items selected from the group consisting of a queue identifier value, a queue priority value, a time to live value, and an access duration value.

6. A system for requesting access to a network as recited in claim 5, wherein at least one of said network nodes requests access based a random back off contention algorithm.

7. A system for requesting access to a network as recited in claim 5, wherein said network nodes request access based on a logical ring access algorithm.

8. A system for requesting access to a network as recited in claim 5, wherein said network is selected from the group consisting of a wireless network, a light frequency network, a power line network, an acoustic network, and a wired network.

9. A system for requesting access to a network as recited in claim 5, wherein said queue identifier value consists of a high queue value and a low queue value.

10. A system for requesting access to a network as recited in claim 5, wherein said queue priority value has a range of 0 to 15.

11. A system for requesting access to a network as recited in claim 5, wherein said time to live value has a range from 0 to 1024.

12. A system for requesting access to a network as recited in claim 5, wherein said access duration has a range from 0 to 1024.

13. A system for requesting access to a network as recited in claim 5, wherein at least of one of said nodes re-requests access based on upper layer packet reassembly.

14. A system for granting access to a network comprising:
A. a plurality of network nodes forming a network;
B. wherein said plurality of network nodes further comprises an access server;
C. wherein said network further comprises one or more active channels having a plurality of time slots; and
D. wherein access to said one or more active channels is granted by said access server.

15. A system for granting access to a network as recited in claim 14, wherein said network is selected from the group consisting of a wireless network, a light frequency network, a power line network, an acoustic network, and a wired network.

16. A system for granting access to a network as recited in claim 14, wherein said access server grants access after a contention period.

17. A system for granting access to a network as recited in claim 16, wherein said access server grants access after a contention period marked by a packet.

18. A system for granting access to a network as recited in claim 14, wherein said access server grants access based on one of the items selected from the group consisting of a queue identifier value, a queue priority value, a time to live value, and an access duration value.

19. A system for granting access to a network as recited in claim 18, wherein said access server grants access based a random back off contention algorithm.

20. A system for granting access to a network as recited in claim 18, wherein said access server grants access based on a logical ring access algorithm.

21. A system for granting access to a network as recited in claim 18, wherein said network is selected from the group consisting of a wireless network, a light frequency network, a power line network, an acoustic network, and a wired network.

22. A system for granting access to a network as recited in claim 18, wherein said queue identifier value consists of a high queue value and a low queue value.

23. A system for granting access to a network as recited in claim 18, wherein said queue priority value has a range of 0 to 15.

24. A system for granting access to a network as recited in claim 18, wherein said time to live value has a range from 0 to 1024.

25. A system for granting access to a network as recited in claim 18, wherein said access duration has a range from 0 to 1024.

26. A system for granting access to a network as recited in claim 18, wherein said access server re-grants access based on packet reassembly.

27. A system for access server relinquishing on a network comprising:
A. a plurality of network nodes forming a network;
B. wherein said plurality of network nodes further comprises an access server;
C. wherein said network further comprises one or more active channels having a plurality of time slots; and
D. wherein said access server relinquishes access mastership based on lack of access requests on said one or more channels.

28. A system for access server relinquishing on a network as recited in claim 27, wherein said access server notifies said network nodes of relinquishing access by on sending out a packet.

29. A system for access server relinquishing on a network as recited in claim 27, wherein said network is selected from the group consisting of a wireless network, a light frequency network, a power line network, an acoustic network, and a wired network.

30. A system for access server arbitration on a network comprising:
A. a plurality of network nodes forming a network;
B. wherein said plurality of network nodes further comprises an access server;
C. wherein said network further comprises one or more active channels having a plurality of time slots; and
D. wherein at least one of said network nodes becomes said access server based on an idle period and a lack of response to access requests.

31. A system for access server arbitration on a network as recited in claim 30, wherein said network is selected from the group consisting of a wireless network, a light frequency network, a power line network, an acoustic network, and a wired network.

32. A method for requesting access to a network comprising:
A. building an access request packet to request access to an active channel on a network node; and
B. sending said access request packet on any active channel to an access server on a time division multiplexed network which has a plurality of time slots wherein one or more of said time slots are grouped together to form said active channel.

33. A method for requesting access to a network as recited in claim 32, wherein sending of said access request packet further comprises sending said access request packet on a network selected from the group consisting of a wireless network, a light frequency network, a power line network, an acoustic network, and a wired network.

34. A method for requesting access to a network as recited in claim 32, wherein building of said access request packet further comprises building an access request packet based on one of the items selected from the group consisting of a queue identifier value, a queue priority value, a time to live value, and an access duration value.

35. A method for requesting access to a network as recited in claim 32, wherein sending of said access request packet further comprises sending said access request packet during a contention period.

36. A method for requesting access to a network as recited in claim 35, wherein sending of said access request packet further comprises sending said access request packet during a contention period marked by a packet.

37. A method for requesting access to a network as recited in claim 35, wherein sending of said access request packet further comprises sending of said access request packet based a random back off contention algorithm:

38. A method for requesting access to a network as recited in claim 35, wherein sending of said access request packet further comprises sending of said access request packet based on a logical ring access algorithm.

39. A method for requesting access to a network as recited in claim 35, wherein sending of said access request packet further comprises sending said access request packet on a network selected from the group consisting of a wireless network, a light frequency network, a power line network, and a wired network.

40. A method for requesting access to a network as recited in claim 32, further comprising the step of re-requesting access from said access server to said channel by said network node based on upper layer packet reassembly.

41. A method for granting access to a network comprising:
A. receiving an access request packet on a time division multiplexed network which has a plurality of time slots wherein one or more of said time slots are grouped together to form an active channel, wherein said access request packet is received by an access server on said active channel from a network node; and
B. sending an access grant packet on said active channel to said network node which grants access to said active channel.

42. A method for granting access to a network as recited in claim 41, wherein receiving of said access request packet further comprises receiving said access request packet on a network selected from the group consisting of a wireless network, a light frequency network, a power line network, an acoustic network, and a wired network.

43. A method for granting access to a network as recited in claim 41, wherein sending of said access grant packet is based on one of the items selected from the group consisting of a queue identifier value, a queue priority value, a time to live value, and an access duration value.

44. A method for granting access to a network as recited in claim 41, wherein receiving of said access request packet further comprises receiving said access request packet during a contention period.

45. A method for granting access to a network as recited in claim 44, wherein receiving of said access request packet further comprises receiving said access request packet during a contention period marked by a packet.

46. A method for granting access to a network as recited in claim 44, wherein receiving of said access request packet further comprises receiving of said access request packet based a random back off contention algorithm.

47. A method for granting access to a network as recited in claim 44, wherein receiving of said access request packet further comprises receiving of said access request packet based on a logical ring access algorithm.

48. A method for granting access to a network as recited in claim 44, wherein receiving of said access request packet further comprises receiving said access request packet on a network selected from the group consisting of a wireless network, a light frequency network, a power line network, an acoustic network, and a wired network.

49. A method for granting access to a network as recited in claim 41, further comprising the step of re-granting access to said network node on said channel by said access server based on upper layer packet reassembly.

50. A method for access server relinquishing on a network comprising:
A. monitoring an active channel on a time division multiplexed network which has a plurality of time slots wherein one or more of said time slots are grouped together to form said active channel and wherein an access server monitors for one or more access request packets from one or more network nodes; and
B. relinquishing access mastership based the number of access request packets seen during one or more contention periods.

51. A method for access server relinquishing on a network as recited in claim 50, wherein relinquishing access mastership further comprises seeing zero access request packets during one or more contention periods.

52. A method for access server relinquishing on a network as recited in claim 50, further comprising the step of sending out a packet to indicate to said one or more network nodes the relinquishing of access mastership.

53. A method for access server relinquishing on a network as recited in claim 50, wherein monitoring an active channel comprises monitoring said active channel on a network selected from the group consisting of a wireless network, a light frequency network, a power line network, an acoustic network, and a wired network.

54. A method for access server arbitration on a network comprising:
A. sending one or more access request packets from a network node on an active channel on a time division multiplexed network which has a plurality of time slots wherein one or more of said time slots are grouped together to form said active channel; and
B. becoming an access server based seeing an idle period and on the number of access response packets received in response to said one or more access request packets.

55. A method for access server arbitration on a network as recited in claim 54 wherein becoming said access server further comprises becoming said access server based on seeing zero access response packets.

56. A method for access server arbitration on a network as recited in claim 54, wherein becoming said access server further comprises becoming said access server which grants access based a contention resolution algorithm.

57. A method for access server arbitration on a network as recited in claim 54, wherein sending said one or more access request packets further comprises sending said access request packets on a network selected from the group consisting of a wireless network, a light frequency network, a power line network, an acoustic network, and a wired network.
